(19) United States
(12) Patent Application Publication
(10) Pub. No.: US 2018/0050942 A1
(43) Pub. Date: Feb. 22, 2018

(54) A LAKE RESERVOIR WATER ENVIRONMENT POLLUTION RESTORATION SYSTEM

(71) Applicant: CHINA INSTITUTE OF WATER RESOURCES AND HYDROPOWER RESEARCH, BEIJING (CN)

(72) Inventors: DENGHUA YAN, BEIJING (CN); WANLI SHI, BEIJING (CN); HAO WANG, BEIJING (CN); YICHENG FU, BEIJING (CN); BAISHA WENG, BEIJING (CN); TIANLING QIN, BEIJING (CN); CHUANZHE LI, BEIJING (CN)

(21) Appl. No.: 15/543,168

(22) PCT Filed: Feb. 15, 2017
(86) PCT No.: PCT/CN2017/073649

§ 371 Date: Jul. 12, 2017

(30) Foreign Application Priority Data
Apr. 13, 2016 (CN) 2016102264959

(51) Int. Cl. C02F 3/32; C02F 3/34; C02F 3/08; C02F 3/10

(52) U.S. Cl. CPC C02F 3/32; C02F 3/34; C02F 2003/001; C02F 3/101; C02F 3/087

(57) ABSTRACT

Disclosed in the present invention are a lake reservoir water environment pollution restoration, comprising an ecological floating bed floating on the surface of lake reservoir water, a plurality of planting beds arranged on the ecological floating bed, a plurality of adsorption nets and reaction beds fixed at the bottom of the ecological floating bed, and a plurality of algae grilles and aeration pipes arranged at the bottom of lake reservoir water, the aeration pipes being connected with an air pump through a vent pipe, a plurality of aeration holes being arranged on the aeration pipes, at least one inflation bag being fixed on the algae grilles, the at least one inflation bag being connected with an air delivery pipe through an inflation pipe, and the input end of the inflation pipe being connected with a second output end of the air pump. The lake reservoir water environment pollution restoration system can achieve all-directional multi-level restoration of water bodies in lake reservoirs, as well as water-surface, in-water and water-bottom multi-level purification, with high restoration efficiency and convenience in maintenance.

### TECHNICAL FIELD

The invention belongs to the technical field of ecological protection and conservation, and in particular relates to a lake reservoir water environment pollution restoration system.

### BACKGROUND ART

Urban lake reservoirs refer to various water lakes, reservoirs and water bodies located within cities. With the increase of demand for hydrophilic living environments in city people, the quantities of other artificial lakes and landscape lakes than natural lake reservoirs in cities are increasing, however, due to the acceleration of urban modernization, the original pervious ground is less and less while the pollution is getting worse. Urban lakes often lack sufficient natural water, and the problem of water quality deterioration has drawn wide attention.

### SUMMARY OF THE INVENTION

An object of the invention is to provide a lake reservoir water environment pollution restoration system having all-directional, multi-level and high restoration success features.

In order to solve the technique problems, the invention provide a lake reservoir water environment pollution restoration system, characterized by comprising an ecological floating bed floating on the surface of lake reservoir water, a plurality of planting beds arranged on the ecological floating bed, a plurality of adsorption nets and reaction beds fixed at the bottom of the ecological floating bed, and a plurality of algae grilles and aeration pipes arranged at the bottom of lake reservoir water, the aeration pipes being connected with a first output end of an air pump through a vent pipe, a plurality of aeration holes being arranged on the aeration pipes, at least one inflation bag being fixed on the algae grilles, the at least one inflation bag (being connected with an air delivery pipe through an inflation pipe, and the input end of the inflation pipe being connected with a second output end of the air pump.

Further, the planting beds each comprise a planting bed body and a planting groove arranged on the planting bed body, and planting holes are uniformly distributed in the planting groove.

Further, two wall climbing bodies are arranged on the two sides of the planting groove, respectively.

Further, the reaction beds each comprise a support fixed at the bottom of the ecological floating bed in a vertically downward manner, and a plurality of fiber bundles arranged on the support, with probiotic microbial flora and coenzymes being attached to the fiber bundles.

Further, two adjacent algae grilles are connected through a cable

Compared with the prior art, the invention has the advantages as follows:

1. The lake reservoir water environment pollution restoration system can restore the content of oxygen dissolved in oxygen-free water bodies by the arrangement of aeration pipes to increase water mobility, thereby solving the problem of dissolved oxygen in eutrophic water bodies.

2. In the lake reservoir water environment pollution restoration system, emergent plants that are planted in the planting beds can solve the problem of water landscape, also oxygen that is generated by photosynthesis on the surface of leaves of emergent plants is delivered to water bodies via plant roots, so that the content of oxygen dissolved in water bodies is increased, and the roots of emergent plants in water bodies can absorb parts of eutrophication sources from water bodies.

3. In the lake reservoir water environment pollution restoration system, probiotic microbial flora attached to the fiber bundles can promote the absorption of eutrophication sources from water bodies by emergent plants, and also lead to the nitrification and digestion of pollutants in water bodies, thereby constructing depth-type ecological purified urban river water bodies.

4. In the lake reservoir water environment pollution restoration system, only algae are accommodated in the algae grilles, which have the effects of phosphorus removal, de-carbonization and odorization and can improve the clarity of lake reservoir water bodies.

5. The lake reservoir water environment pollution restoration system can achieve all-directional multi-level restoration of water bodies in lake reservoirs, as well as water-surface, in-water and water-bottom multi-level purification, with high restoration efficiency and convenience in maintenance.

6. The lake reservoir water environment pollution restoration system has large market capacity, wide application prospect and great market and social values.

### BRIEF DESCRIPTION OF THE DRAWINGS

FIG. 1 is a structural schematic view of one embodiment of the invention,

FIG. 2 is a top view of planting beds of one embodiment of the invention,

FIG. 3 is a structural schematic view of reaction beds of one embodiment of the invention,

Where, 1. ecological floating bed 2. planting bed 21. planting bed body 22. planting groove 23. planting hole 24 wall climbing body 3. adsorption net 4. reaction bed 41. support 42. fiber bundle 5. algae grille 51. cable 52. inflation bag 6. air pump 7. vent pipe 8. aeration pipe 81. aeration hole 9. air delivery pipe 91. inflation pipe

### DETAILED DESCRIPTION OF THE INVENTION

The embodiments of the disclosure will be described in detail below, to facilitate the understanding of the disclosure by those skilled in the art, however, it should be understood that the disclosure is not limited by the embodiments, and for those skilled in the art, without departing from the spirit and scope of the disclosure defined by the claims appended, various modifications will become apparent, and all inventions utilizing the concept of the disclosure fall into the scope.

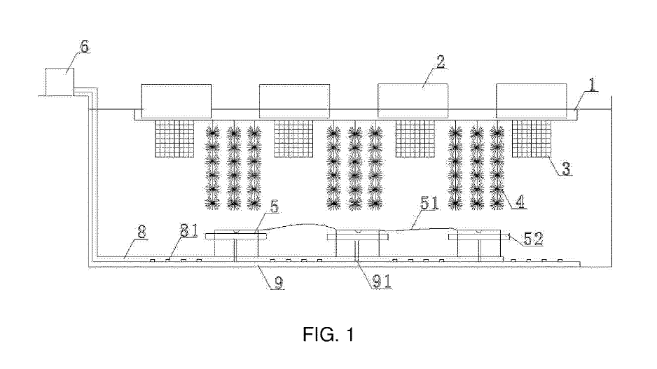

As shown in FIG. 1, a lake reservoir water environment pollution restoration system, comprises an ecological floating bed 1 floating on the surface of lake reservoir water, a plurality of planting beds 2 fixed on the ecological floating bed 1, a plurality of adsorption nets 3 and reaction beds 4 fixed at the bottom of the ecological floating bed 1, and a plurality of algae grilles 5 and aeration pipes 8 arranged at the bottom of lake reservoir water.

Wherein, the aeration pipes 8 are connected with a first output end of an air pump 6 through a vent pipe 7, and a plurality of aeration holes 81 are arranged on the aeration pipes 8, such arrangement can restore the content of oxygen dissolved in the oxygen-free water body and increase water mobility, thereby solving the fundamental problem of dissolved oxygen in the eutrophic water body.

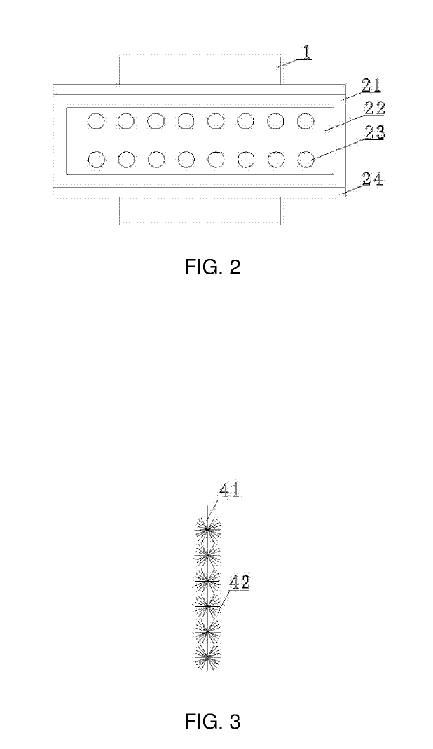

As shown in FIG. 2, the planting beds 2 each comprise a planting bed body 21 and a planting groove 22 arranged on the planting bed body 21, and planting holes 23 are uniformly distributed in the planting groove 22. Emergent plants are planted in the planting holes 23 and can solve the problem of water landscape, also oxygen that is generated by photosynthesis on the surface of leaves of emergent plants is delivered to the water body via plant roots, so that the content of oxygen dissolved in the water body is further increased, and the roots of emergent plants in the water body can absorb parts of eutrophication sources from the water body. Further, two wall climbing bodies 24 are arranged on the two sides of the planting groove 22, respectively. On the one hand, the wall climbing bodies 24 can be used for sculpting of the emergent plants, on the other hand, can avoid the cleaning problem caused by the spread of the emergent plants.

As shown in FIG. 3, the reaction beds (4) each comprise a support 41 fixed at the bottom of the ecological floating bed 1 in a vertically downward manner, and a plurality of fiber bundles 42 arranged on the support 41, with probiotic microbial flora and coenzymes being attached to the fiber bundles 42. The probiotic microbial flora can promote the absorption of eutrophication sources from the water body by the emergent plants, and also lead to the nitrification and digestion of pollutants in the water body, thereby constructing a depth-type ecological purified urban river water body. Also, the adsorption nets 3 are nitrogen/phosphorus-adsorbing films which can absorb nitrogen and phosphorus in water for the supply to the roots of the emergent plants.

Only algae are accommodated in the algae grilles 5, algae have good effects of phosphorus removal, de-carbonization and odorization and can improve the clarity of lake reservoir water bodies. Further, two adjacent algae grilles 5 are connected through a cable 51, to facilitate the cleaning of algae in the algae grilles 5 at the preset time. Furthermore, at least one inflation bag 52 is fixed on the algae grilles 5, the inflation bag 52 is connected with an air delivery pipe 9 through an inflation pipe 91, and the input end of the inflation pipe 91 is connected with a second output end of the air pump 6. In the case of cleaning the algae in the algae grilles, the inflation bag 52 is inflated through the second output end of the air pump 6, so that the algae grilles 5 automatically float on the water surface. In the case of putting the algae grilles 5 in water, all that is needed is to release the air from the inflation bag 52, which is convenient and practical.

In summary, the lake reservoir water environment pollution restoration system can achieve all-directional multi-level restoration of the water body in the lake reservoir, with high restoration efficiency and convenience in maintenance.

1. A lake reservoir water environment pollution restoration system, characterized by comprising an ecological floating bed floating on the surface of lake reservoir water, a plurality of planting beds (2) arranged on the ecological floating bed (1), a plurality of adsorption nets (3) and reaction beds (4) fixed at the bottom of the ecological floating bed (1), and a plurality of algae grilles (5) and aeration pipes (8) arranged at the bottom of lake reservoir water,
the aeration pipes (8) being connected with a first output end of an air pump (6) through a vent pipe (7), a plurality of aeration holes (81) being arranged on the aeration pipes (8),
at least one inflation bag (52) being fixed on the algae grilles (5), the at least one inflation bag (52) being connected with an air delivery pipe (9) through an inflation pipe (91), and the input end of the inflation pipe (91) being connected with a second output end of the air pump (6).

2. The lake reservoir water environment pollution restoration system according to claim 1, characterized in that the planting beds (2) each comprise a planting bed body (21) and a planting groove (22) arranged on the planting bed body (21), and planting holes (23) are uniformly distributed in the planting groove (22).

3. The lake reservoir water environment pollution restoration system according to claim 2, characterized in that two wall climbing bodies (24) are arranged on the two sides of the planting groove (22), respectively.

4. The lake reservoir water environment pollution restoration system according to claim 1, characterized in that the reaction beds (4) each comprise a support (41) fixed at the bottom of the ecological floating bed (1) in a vertically downward manner, and a plurality of fiber bundles (42) arranged on the support (41), with probiotic microbial flora and coenzymes being attached to the fiber bundles (42).

5. The lake reservoir water environment pollution restoration system according to claim 1, characterized in that two adjacent algae grilles (5) are connected through a cable (51).

6. The lake reservoir water environment pollution restoration system according to claim 1, characterized in that the adsorption nets (3) are nitrogen/phosphorus-adsorbing films.
